(19) United States
(12) Patent Application Publication
(10) Pub. No.: US 2026/0296112 A1
(43) Pub. Date: Oct. 1, 2026

(54) Tire Comprising a Sidewall with at Least One High-Contrast Sidewall Element

(71) Applicant: COMPAGNIE GENERALE DES ETABLISSEMENTS MICHELIN, Clermont-Ferrand (FR)

(72) Inventors: Olivier MUHLHOFF, Clermont-Ferrand Cedex 9 (FR); Aline RIOU, Clermont-Ferrand Cedex 9 (FR); Sylvain MAYER, Clermont-Ferrand Cedex 9 (FR)

(21) Appl. No.: 19/479,474

(22) PCT Filed: Apr. 26, 2024
(86) PCT No.: PCT/EP2024/061610

§ 371 Date: Oct. 28, 2025

(30) Foreign Application Priority Data
May 3, 2023 (FR) FR2304442

(51) Int. Cl. B60C 13/00

(52) U.S. Cl. CPC B60C 13/001

(57) ABSTRACT

A tire (1) for a vehicle, having at least one sidewall (2), with at least one high-contrast sidewall element (3) constituted by a texture comprising protuberances (4, 5), which stand out in relief with respect to a sidewall surface (21), in contact with the atmospheric air, and/or cavities (6), which are recessed with respect to the sidewall surface (21). A rubber composition of the sidewall (2) is described exhibiting a good compromise between tear strength and rolling resistance. The weight ratio between the content of reinforcing filler and the content of plasticizing agent is at most equal to 4.50, the sum of the content of reinforcing filler and of the content of rubber crumb is at least equal to 30 phr and at most equal to 70 phr, and the weight ratio between the content of rubber crumb and the content of reinforcing filler is at least equal to 0.20 and at most equal to 2.50.

The present invention relates to a tire for a vehicle, comprising a sidewall with at least one high-contrast sidewall element.

A tire comprises two sidewalls, a sidewall being the tire portion that connects one end of the tread, which is intended to come into contact with the ground, to a bead, which is intended to be mounted on a rim.

In the following text, the external surface of a sidewall, which is in contact with the atmospheric air, is referred to, more simply, by the term “sidewall surface”. A sidewall surface comprises generally at least one graphical element and/or, possibly, an aesthetic element. A graphical element, which is usually called a marking and comprises letters, numbers or symbols, is generally intended to impart technical, commercial or legal information.

By definition, a high-contrast sidewall element means a sidewall surface element that is constituted by a specific texture different than that of the sidewall surface, which is usually smooth. This texture gives said high-contrast sidewall element a darker appearance than that of any sidewall surface portion adjacent to said high-contrast sidewall element, such that this high-contrast sidewall element can be visually distinguished from any adjacent sidewall surface portion. A high-contrast sidewall element may be a graphical or aesthetic element, or a sidewall surface portion surrounding said graphical or aesthetic element, making said graphical or aesthetic element particularly visible on the sidewall surface.

Thus, in order to bring out the graphical elements or aesthetic elements of the sidewall surface, it is an ongoing concern of tire designers to create the high-contrast sidewall elements.

It is known practice to create the texture of these high-contrast sidewall elements by way of protuberances that stand out in relief with respect to the surface of the sidewall, or by way of cavities that are recessed with respect to the surface of the sidewall, or by way of a combination of protuberances and cavities. This texture is constituted by a rubber material, also referred to as rubber composition or elastomer composition, which is identical to that of the sidewall portion in contact with the atmospheric air, since this texture is formed integrally with the sidewall.

High-contrast sidewall elements constituted by a texture comprising protuberances in the form of strands or strips have been described in the documents WO 2007045425 A1, WO 2011036061 A1 and WO 2014202731 A1. High-contrast sidewall elements constituted by a texture comprising cavities that are recessed with respect to the sidewall surface have been described in the document WO 2014040967 A1.

The texture of a high-contrast sidewall element is usually created by moulding during the curing of the tire. The corresponding mould element, which is intended to create the texture of the high-contrast sidewall element, is produced, by way of non-limiting example, by machining or by laser engraving. The texture of a high-contrast sidewall element can also be created directly on the sidewall surface of the tire after curing, for example by laser engraving. The texture is consequently constituted by the same material as the rest of the sidewall.

The texture of the high-contrast sidewall elements, comprising protuberances in the form of strands or strips, makes it possible to absorb a large proportion of the incident light rays, following one or more successive reflections on the walls of the protuberances. This makes it possible to give the texture a blacker appearance and, consequently, to improve its contrast and therefore its visibility with respect to any adjacent sidewall surface portion. Furthermore, this particular texture makes it possible to achieve a pleasant touch on the sidewall surface, of the “velvet” type. Lastly, the texture used has a water-repellent and slightly hydrophobic effect. In one particular embodiment, the texture may be positioned on a surface that is set back with respect to the sidewall surface, such that it is embedded in the sidewall, this having the advantage of protecting it, for example, from the wear caused by the sidewall surface scuffing against a kerb.

Similarly, the texture of the high-contrast sidewall elements, comprising cavities that are recessed with respect to the sidewall surface, makes it possible to absorb a large proportion of the incident light rays, following one or more successive reflections on the walls of the cavities. This specific texture has the advantage of being set back with respect to the sidewall surface, making it possible to ensure the durability of said texture by protecting it from the wear caused by the sidewall surface scuffing against a kerb. It also has the advantage of not disturbing the aerodynamic air flow, in the vicinity of the sidewall surface, while the tire is running.

On the tire sidewall surfaces comprising high-contrast sidewall elements, a change over time in the visual appearance of the texture of said high-contrast sidewall elements has been observed, and this can result, in particular, from the appearance of crazing or microcracks, linked both with the conditions of use of the tire and the ageing of the material.

It is therefore necessary, in order to obtain a high-contrast sidewall element that is durable throughout the lifetime of the tire, to be able to reduce this crazing, or at the very least to delay the appearance thereof, but with a limited impact on the hysteresis of the material of the sidewall, and therefore on the rolling resistance of the tire. Specifically, the resistance to cracking (or tear strength) and the hysteresis of a rubber composition are known to be linked.

Increasing the durability of a high-contrast sidewall element is, indeed, a significant commercial challenge for a tire manufacturer. Thus, for example, when a user replaces only the tires fitted at the front of their vehicle, they may find a significant difference between the visual appearance of a high-contrast sidewall element seen on the new tires fitted at the front of the vehicle and that seen on the worn tires fitted at the rear of the vehicle. This difference in visual appearance between the front and rear tires may be deemed unacceptable by the user, especially when their vehicle is a sports or luxury vehicle.

Therefore, the inventors set themselves the objective of increasing, for a tire comprising a sidewall with at least one high-contrast sidewall element, the durability of the visual appearance of said high-contrast sidewall element, with the aid of a suitable rubber composition of the sidewall, in particular in the vicinity of the sidewall surface, exhibiting a satisfactory compromise between tear strength and hysteresis.

This objective has been achieved by a tire for a vehicle, comprising a sidewall with at least one high-contrast sidewall element:
the high-contrast sidewall element being constituted by a texture comprising protuberances, which stand out in relief with respect to a sidewall surface, in contact with the atmospheric air, and/or cavities, which are recessed with respect to the sidewall surface,
the sidewall comprising a rubber composition based on an elastomer matrix, on at least one reinforcing filler, on at least one crosslinking system, on at least one plasticizing agent and on at least one rubber crumb,
the weight ratio between the content of reinforcing filler, expressed in phr, and the content of plasticizing agent, expressed in phr, being at most equal to 4.50,
the sum of the content of reinforcing filler, expressed in phr, and of the content of rubber crumb, expressed in phr, being at least equal to 30 phr and at most equal to 70 phr,
and the weight ratio between the content of rubber crumb, expressed in phr, and the content of reinforcing filler, expressed in phr, being at least equal to 0.20 and at most equal to 2.50.

According to the invention, the high-contrast sidewall element is constituted by a texture comprising protuberances, which stand out in relief with respect to a sidewall surface, in contact with the atmospheric air, and/or cavities, which are recessed with respect to the sidewall surface.

Also according to the invention, the sidewall comprises a rubber composition based on an elastomer matrix, on at least one reinforcing filler, on at least one crosslinking system, on at least one plasticizing agent, and on at least one rubber crumb.

The expression “rubber composition based on” should be understood as meaning a rubber composition comprising the mixture and/or the product of the in situ reaction of the various constituents used, some of these constituents being able to react and/or being intended to react with each other, at least partially, during the various phases of manufacture of the rubber composition, it thus being possible for the rubber composition to be in the completely or partially crosslinked state or in the non-crosslinked state.

A rubber composition comprises at least one and often several elastomers, in particular several diene elastomers. This mixture of elastomers, in particular diene elastomers, is referred to as an elastomer matrix. Preferably, the elastomer matrix comprises at least two different diene elastomers.

The term “elastomer” means a polymer, i.e. a homopolymer or a copolymer, having elastic properties obtained after crosslinking. The term rubber is a common synonym for elastomer.

The term “diene elastomer” (or, without distinction, “diene rubber”), whether natural or synthetic, is understood as meaning an elastomer at least partially composed of diene monomer units (monomers bearing two conjugated or non-conjugated carbon-carbon double bonds). Diene elastomers are non-thermoplastic.

Diene elastomers can be classified into two categories: “essentially unsaturated” diene elastomers and “essentially saturated” diene elastomers. An “essentially unsaturated” diene elastomer is a diene elastomer resulting at least partly from conjugated diene monomers, having a content of units of diene origin (conjugated dienes) which is greater than 15% (mol %). Thus, diene elastomers such as butyl rubbers or copolymers of dienes and of α-olefins of EPDM type do not fall within the above definition and can, in particular, be described as “essentially saturated” diene elastomers (low or very low content of units of diene origin, always less than 15%).

The expression “diene elastomer capable of being used in the rubber compositions in accordance with the invention” means in particular:
a) any homopolymer of a conjugated or non-conjugated diene monomer having from 4 to 18 carbon atoms;
b) any copolymer of a conjugated or non-conjugated diene having from 4 to 18 carbon atoms and of at least one other monomer; the other possibly being ethylene, an olefin or a conjugated or non-conjugated diene.

Conjugated dienes that are suitable include conjugated dienes having from 4 to 12 carbon atoms, in particular 1,3-dienes, in particular such as 1,3-butadiene and isoprene.

Non-conjugated dienes that are suitable include non-conjugated dienes having from 6 to 12 carbon atoms, such as 1,4-hexadiene, ethylidene norbornene or dicyclopentadiene.

Olefins that are suitable include vinylaromatic compounds having from 8 to 20 carbon atoms and aliphatic α-monoolefins having from 3 to 12 carbon atoms.

Vinylaromatic compounds that are suitable include, for example, stirene, ortho-, meta- or para-methylstirene, the “vinyltoluene” commercial mixture or para-(tert-butyl)stirene.

Aliphatic α-monoolefins that are suitable include in particular acyclic aliphatic α-monoolefins having from 3 to 18 carbon atoms.

More particularly, the diene elastomer is:
(a′) any homopolymer of a conjugated diene monomer, in particular any homopolymer obtained by polymerization of a conjugated diene monomer having from 4 to 12 carbon atoms;
(b′) any copolymer obtained by copolymerization of one or more conjugated dienes with one another or with one or more vinylaromatic compounds having from 8 to 20 carbon atoms;
(c′) any copolymer obtained by copolymerization of one or more conjugated or non-conjugated dienes with ethylene, an α-monoolefin or a mixture thereof, such as, for example, the elastomers obtained from ethylene, from propylene with a non-conjugated diene monomer of the abovementioned type.

A reinforcing filler, intended to reinforce a rubber composition, may be an organic filler such as carbon black, or an inorganic filler such as silica or alumina in combination with a coupling agent between the inorganic filler and the diene elastomer, or a mixture of these types of filler.

The crosslinking system may be any type of system known to those skilled in the art in the field of rubber compositions for tires. It may in particular be based on sulfur and/or on peroxide and/or on bismaleimides. Preferably, the crosslinking system is based on sulfur; it is then referred to as a vulcanization system. The sulfur may be provided in any form, in particular in the form of molecular sulfur or a sulfur-donating agent. At least one vulcanization accelerator is also preferably present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or known vulcanization retarders. Use may be made, as accelerator, of any compound that is capable of acting as an accelerator of the vulcanization of diene elastomers in the presence of sulfur, in particular accelerators of the thiazole type, and also derivatives thereof, or accelerators of the sulfenamide, thiuram, dithiocarbamate, dithiophosphate, thiourea and xanthate types.

A plasticizing agent is a usual processing aid that is known to those skilled in the art and conventionally used in rubber compositions. A plasticizing agent may be selected from the group consisting of plasticizing oils, plasticizing resins having a high glass transition temperature Tg, and combinations thereof.

Any extender oil, whether aromatic or non-aromatic in nature, known for its plasticizing properties towards elastomers, can be used. At ambient temperature (23° C.), these oils, which are more or less viscous, are liquids (that is to say, as a reminder, substances which have the ability to take on the shape of their container), as opposed, in particular, to hydrocarbon resins having a high Tg, which are by nature solids at ambient temperature. The plasticizing oil generally has a glass transition temperature Tg below −20° C., preferably below −40° C. The glass transition temperature Tg of the plasticizing oil is measured according to the standard ASTM D3418 (2008).

By definition, a hydrocarbon resin having a high Tg, typically at least equal to 30° C., is solid at room temperature and ambient pressure (23° C., 1 atm), whereas a plasticizing oil is liquid at room temperature and a hydrocarbon resin having a low Tg is viscous at room temperature. Hydrocarbon resins, also known as hydrocarbon plasticizing resins, are polymers that are well known to those skilled in the art, essentially based on carbon and hydrogen but which may include other types of atoms, for example oxygen, and can be used in particular as plasticizers or tackifiers in polymer matrices. They are by nature at least partially miscible (i.e. compatible) at the contents used with the polymer compositions for which they are intended, so as to act as true diluents. In a known manner, these hydrocarbon resins may also be described as thermoplastic resins in the sense that they soften when heated and can thus be moulded. The glass transition temperature Tg of the plasticizing resin is measured according to the standard ASTM D3418 (2008).

A rubber composition, in particular in contact with the atmospheric air, such as a rubber composition for a tire sidewall, can also contain anti-ozone waxes, such as, for example, paraffin waxes, microcrystalline waxes or mixtures of paraffin and microcrystalline waxes.

These waxes consist of a mixture of linear alkanes and of non-linear alkanes (isoalkanes, cycloalkanes, branched alkanes) resulting from the refining of oil or from the catalytic hydrogenation of carbon monoxide (Fischer-Tropsch process) predominantly comprising chains of at least 20 carbon atoms. The distribution of the alkanes is determined by gas chromatography coupled with a flame ionization detector (“CPG-FID”). The chromatogram is evaluated using the EWF (European Wax Federation) method.

All known anti-ozone waxes can be used, including natural waxes, such as, for example, candelilla wax or carnauba wax. These waxes may, furthermore, be used as blends.

Anti-ozone waxes are commercially available, for example “Varazon 4959”, “Varazon 6500” and “Varazon 6810” from Sasol, “Ozoace 0355” from Nippon Seiro, “Negozone 9343” from H&R and “H3841” from Yanggu Huatai.

According to the invention, the rubber composition comprises, in addition to the elastomer matrix, a rubber crumb (also referred to as “crumb rubber”) which is in the form of granules, optionally put into the form of a rubber slab, which is a recycling product.

Generally, rubber crumbs result from a grinding or from a micronization of vulcanized rubber compositions already used for a first application, for example in tires, shoe soles, seals. They are therefore a product of the recycling of these materials.

As is known, rubber crumbs can be more particularly obtained by reducing into granules worn tires from which the reinforcing materials such as steel or textile fibres have been removed.

Rubber crumbs can be prepared by cryogenic grinding of worn tires, for example according to the method described in the document U.S. Pat. No. 7,445,170, comprising the successive and independent steps of granulation, separation of the metal and textile reinforcers, cooling and micronization in order to obtain a coarse distribution of micronic particles of vulcanized mixture (also referred to as microparticles). This micronization can be carried out using a conical impact mill as described in the document U.S. Pat. No. 7,861,958. The cryogenized input enters the mill (for example, the CUM150 mill from Netzsch or the CW250 mill from Alpine may be used), and is then transferred by gravity to a rotor rotating at high speed. The cryogenized input is thus sprayed onto the walls of the rotor chamber multiple times, leading to its micronization. The particles may then pass through a series of two vibrating screens of the same size in order to separate the last elements not made of vulcanized mixture. A coarse distribution of micronic particles of vulcanized mixture is obtained. The term “microparticles” is understood to mean particles which have a size, namely their diameter in the case of spherical particles or their greatest dimension in the case of anisometric particles, of a few tens of or a few hundred microns. The size of the microparticles can be determined by techniques known to those skilled in the art, such as microscopy, for example. The rubber crumbs are commercially available from suppliers such as Lehigh Technology, for example.

The rubber crumbs may be simple ground or micronized rubber materials, without other treatment. However, it is also known practice to subject rubber crumbs to a treatment in order to modify them. This treatment can consist of a chemical functionalization or devulcanization modification. It can also be a thermomechanical, thermochemical, biological treatment.

According to a first essential feature of the invention, the weight ratio between the content of reinforcing filler, expressed in phr, and the content of plasticizing agent, expressed in phr, is at most equal to 4.50.

According to a second essential feature of the invention, the sum of the content of reinforcing filler, expressed in phr, and of the content of rubber crumb, expressed in phr, is at least equal to 30 phr and at most equal to 70 phr.

According to a third essential feature of the invention, the weight ratio between the content of rubber crumb, expressed in phr, and the content of reinforcing filler, expressed in phr, is at least equal to 0.20 and at most equal to 2.50.

The contents of the various constituents are expressed in “phr”. The unit “phr” represents the part by weight per hundred parts by weight of elastomer or of rubber. The unit “phr” is short for “parts per hundred of rubber”. The elastomers of the rubber crumb are excluded from the weight of elastomer referred to.

The combination of these essential features of the rubber composition gives the sidewall, in particular any high-contrast sidewall element, satisfactory tear strength, combined with a low hysteresis contributing to low rolling resistance of the tire.

Advantageously, the weight ratio between the content of reinforcing filler, expressed in phr, and the content of plasticizing agent, expressed in phr, is at least equal to 1.50, preferably at least equal to 2.00, and at most equal to 4.00, and more preferably at least equal to 2.00 and at most equal to 3.50.

Also advantageously, the sum of the content of reinforcing filler, expressed in phr, and of the content of rubber crumb, expressed in phr, is at least equal to 35 phr and at most equal to 65 phr, preferably at least equal to 35 phr and at most equal to 63 phr, and more preferably at least equal to 40 phr and at most equal to 63 phr.

Also advantageously, the weight ratio between the content of rubber crumb, expressed in phr, and the content of reinforcing filler, expressed in phr, is at least equal to 0.25 and at most equal to 1.50.

Preferably, the content of reinforcing filler is at least equal to 5 phr and at most equal to 70 phr, preferably at least equal to 5 phr and at most equal to 60 phr, more preferably at least equal to 5 phr and at most equal to 55 phr, even more preferably at least equal to 10 phr and at most equal to 50 phr, and even more preferably at least equal to 20 phr and at most equal to 45 phr.

More preferably, the reinforcing filler predominantly comprises carbon black.

When reference is made to a “predominant” compound, this means, within the meaning of the present invention, that this compound is predominant among the compounds of the same type in the composition, meaning that it is the one which represents the greatest amount by weight among the compounds of the same type, and preferably more than 50% by weight, more preferably more than 75% by weight. Thus, a “predominant” filler is the one which represents the greatest weight among the fillers of the composition.

Preferably, the content of plasticizing agent is at least equal to 2 phr and at most equal to 28 phr, preferably at least equal to 7 phr and at most equal to 24 phr, and more preferably at least equal to 10 phr and at most equal to 20 phr.

More preferably, the at least one plasticizing agent is selected from the group consisting of plasticizing oils, plasticizing resins having a high Tg, and combinations thereof.

Even more preferably, the plasticizing agent is a plasticizing oil selected from the group consisting of naphthenic oils, paraffinic oils, naphthenic oils, DAE oils, polyolefin oils, MES oils, TDAE oils, RAE oils, TRAE oils, SRAE oils, mineral oils, vegetable oils, ether plasticizers, ester plasticizers, phosphate plasticizers, sulfonate plasticizers, and mixtures of these oils, and more preferably is an oil selected from the group consisting of MES oils, TDAE oils, RAE oils, TRAE oils, SRAE oils, mineral oils, vegetable oils, and mixtures of these plasticizing oils.

Preferably, the elastomer matrix comprises at least one isoprene elastomer and at least one butadiene elastomer.

As is known, the term “isoprene elastomer” means a homopolymer or copolymer of isoprene. In other words an isoprene elastomer may be selected from the group consisting of natural rubber (NR), synthetic polyisoprenes (IR), the various isoprene copolymers, and mixtures of these elastomers. Isoprene copolymers include in particular isobutene/isoprene (butyl rubber—IIR), isoprene/stirene (SIR), isoprene/butadiene (BIR) or isoprene/butadiene/stirene (SBIR) copolymers. Preferably, the isoprene elastomer may be selected from the group consisting of natural rubber, synthetic cis-1,4-polyisoprenes, and combinations thereof. Even more preferably, the isoprene elastomer is selected from the group consisting of natural rubber, synthetic polyisoprenes having a content (mol %) of cis-1,4 bonds of greater than 90% (even more preferentially of greater than 98%), and the combination of these elastomers.

As is known, the term “butadiene elastomer” means a homopolymer or copolymer of butadiene. In other words, a butadiene elastomer may be selected from the group consisting of polybutadienes (BR), the various butadiene copolymers, and mixtures of these elastomers. Butadiene copolymers include in particular butadiene/stirene (SBR) or ethylene/butadiene (EBR) copolymers. Preferably, the butadiene elastomer may be a cis-1,4-polybutadiene; in particular a polybutadiene having a content (mol %) of cis-1,4 bonds of greater than 90%, even more preferentially of greater than 96%.

More preferably, the elastomer matrix comprises at least one isoprene elastomer at a content at least equal to 20 phr and at most equal to 80 phr, preferably at least equal to 30 phr and at most equal to 70 phr, more preferably at least equal to 35 phr and at most equal to 65 phr, and at least one butadiene elastomer at a content at least equal to 20 phr and at most equal to 80 phr, preferably at least equal to 30 phr and at most equal to 70 phr, more preferably at least equal to 35 phr and at most equal to 65 phr.

Preferably, the content of rubber crumb is at least equal to 2 phr and at most equal to 35 phr, preferably at least equal to 5 phr and at most equal to 33 phr, more preferably at least equal to 6 phr and at most equal to 32 phr, even more preferably at least equal to 7 phr and at most equal to 31 phr, and even more preferably at least equal to 8 phr and at most equal to 30 phr.

Note that, within the meaning of the present invention, the rubber crumb is not considered to be a reinforcing filler. Consequently, the content of rubber crumb is not included in the content of reinforcing filler.

Advantageously, the rubber crumb has a microparticle size distribution such that it comprises less than 1% by mass of particles not retained through a 600 μm screen and less than 10% by mass of microparticles not retained through a 105 μm screen, relative to the total mass of the microparticles of rubber crumb. Preferably, the rubber crumb has a microparticle size distribution such that it comprises less than 1% by mass of microparticles not retained through a 600 μm screen and less than 10% by mass of microparticles not retained through a 177 μm screen, relative to the total mass of the microparticles of rubber crumb. The distribution of the microparticles of rubber crumb is determined according to the standard ASTM D5644-01 (2013).

To obtain such a rubber crumb having such distributions, an additional screening step according to a size criterion was carried out. Screening can be carried out by different technologies (vibration, centrifugation, suction) that are known to those skilled in the art. Preferably, this screening step is carried out using a series of screens stacked in order of size (screens with calibrated mesh sizes such as the commercial products from Gericke, for example). Thus, the larger particles are retained on the screen while the smaller ones pass to the lower stage on the next screen. Those skilled in the art will understand that the distributions considered below may be composed of all the particles that pass through a given screen or of all the particles retained between 2 stages.

Preferably, the rubber crumb has a microparticle size distribution such that it comprises less than 1% by mass of microparticles not retained through a 250 μm screen and less than 10% by mass of microparticles not retained through a 177 μm screen, relative to the total mass of the microparticles of rubber crumb.

Advantageously, the rubber crumb is a rubber crumb that has not undergone any modification by a treatment selected from the group consisting of heat, mechanical, biological and chemical treatments, and combinations thereof.

The rubber composition described above, with all its embodiments, is, in particular, the constituent material of the high-contrast sidewall element, which is formed integrally with the sidewall and is constituted by a texture comprising protuberances, which stand out in relief with respect to a sidewall surface, in contact with the atmospheric air, and/or cavities, which are recessed with respect to the sidewall surface.

According to a first texture embodiment, the high-contrast sidewall element is constituted by a texture comprising protuberances, which stand out in relief with respect to a sidewall surface, having a mean height at least equal to 0.2 mm and at most equal to 0.8 mm, preferably at least equal to 0.25 mm and at most equal to 0.5 mm.

The mean height is understood to be the arithmetic mean of the heights of all of the protuberances. If the mean height is less than 0.2 mm, the texture is likely to disappear rapidly under the effect of repeated scuffing of the sidewall surface against kerbs. If the mean height is greater than 0.8 mm, the time for producing the mould part intended to mould the protuberances becomes prohibitive in relation to the desired contrast effect.

According to a first embodiment of the protuberances, the high-contrast sidewall element is constituted by a texture comprising protuberances in the form of strands, which are distributed at a surface density at least equal to 5 strands/mm² and at most equal to 100 strands/mm², preferably at least equal to 8 strands/mm² and at most equal to 50 strands/mm², and even preferably at least equal to 11 strands/mm² and at most equal to 30 strands/mm².

A texture comprising at least 5 strands/mm² has a uniform visual appearance, since, with a smaller number, the human eye perceives separate strands. In a texture comprising a large number of strands, typically above 100 strands/mm², the strands necessarily have a small diameter, making the texture less resistant to pull-out, for example, in the case of repeated scuffing of the sidewall surface against kerbs.

Advantageously, the high-contrast sidewall element is constituted by a texture comprising protuberances in the form of strands having a mean diameter at least equal to 0.03 mm and at most equal to 0.5 mm.

The mean diameter is understood to be the arithmetic mean of the diameters of a given strand, which are measured over the entire height of the strand. This mean diameter is not necessarily constant from one strand to another. Such a texture having strands, which is produced by moulding, is less sensitive to pulling out of the strands during demoulding, which would then remain stuck in the mould, requiring specific cleaning of the latter. Moreover, this pulling out of strands would impair the visual uniformity of the high-contrast element.

According to a preferred variant of the first embodiment of the protuberances, the high-contrast sidewall element is constituted by a texture comprising protuberances in the form of strands having a diameter that decreases from a strand base, interfacing with the sidewall surface, and a free strand tip.

Such a texture having strands, which is produced by moulding, is less sensitive to pulling out of the strands during demoulding, which would then remain stuck in the mould, requiring specific cleaning of the latter. Moreover, this pulling out of strands would impair the visual uniformity of the high-contrast element.

According to a second embodiment of the protuberances, the high-contrast sidewall element is constituted by a texture comprising protuberances in the form of strips distributed at a spacing at least equal to 0.1 mm and at most equal to 0.5 mm, preferably at least equal to 0.15 mm and at most equal to 0.3 mm.

The strips are protuberances that are easier to mould, since their shape makes it easier for the elastomer material to flow and therefore for them to be moulded. If the spacing between the strips is less than 0.1 mm, the strips are too fragile. If the spacing between the strips is greater than 0.5 mm, the human eye perceives the separate strips.

Advantageously, the high-contrast sidewall element is constituted by a texture comprising protuberances in the form of strips having a mean width at least equal to 0.03 mm and at most equal to 0.5 mm.

The mean width is understood to be the arithmetic mean of the widths of a given strip, which are measured over the entire height of the strip. This mean width is not necessarily constant from one strip to another.

According to a preferred variant of the second embodiment of the protuberances, the high-contrast sidewall element is constituted by a texture comprising protuberances in the form of strips having a width that decreases from a strip base, interfacing with the sidewall surface, and a free strip tip.

According to a second texture embodiment, the high-contrast sidewall element is constituted by a texture comprising cavities, which are recessed with respect to a sidewall surface, having a mean depth at least equal to 0.2 mm and at most equal to 0.7 mm, preferably at least equal to 0.25 mm and at most equal to 0.4 mm.

The mean depth is understood to be the arithmetic mean of the depths of all of the cavities. Although this texture embodiment is able to be produced by moulding, it is particularly suitable for being produced by laser ablation of the material, or laser engraving, on the cured tire.

Advantageously, the high-contrast sidewall element is constituted by a texture comprising cavities, the openings of which onto the sidewall surface are distributed at a surface density at least equal to 5 openings/mm² and at most equal to 100 openings/mm², preferably at least equal to 8 openings/mm² and at most equal to 50 openings/mm², and even preferably at least equal to 11 openings/mm² and at most equal to 30 openings/mm².

A texture comprising at least 5 openings/mm² has a uniform visual appearance, since, with a smaller number, the human eye perceives separate openings. A texture comprising more than 100 openings/mm² behaves like a virtually smooth surface which directly reflects light, this not being the desired effect.

Also advantageously, the high-contrast sidewall element is constituted by a texture comprising cavities, the openings of which onto the sidewall surface have a mean diameter at least equal to 0.03 mm and at most equal to 0.5 mm.

The mean diameter is understood to be an arithmetic mean of the diameters, which are not necessarily identical, of the openings onto the sidewall surface.

The contrast between a high-contrast sidewall element and a sidewall surface portion adjacent to said high-contrast sidewall element is caused by a difference in lightness between the two zones. An adjacent surface portion, which may be smooth or be provided with a different texture, has a lightness greater than that of the texture of said high-contrast sidewall element, meaning that it has a visually lighter appearance.

The lightness can be defined by the luminance, expressed in candela/m², which measures the luminous flux coming from a lit surface, which is reflected into the eye of the observer. However, the relationship between the luminance and the visual perception of the lightness is not linear and is complex. For this reason, from a practical standpoint, the International Commission on Illumination (CIE) has defined the lightness L*, a parameter which characterizes the capacity of a surface to reflect light, on the basis of the luminance of the light produced by a primary or secondary source, expressed in candelas per metre squared (cd/m²), relative to the luminance of white taken as a reference. Thus, in the following text, lightness L* is expressed using a scale that ranges from 0 to 100 in accordance with the L*a*b* colour model adopted in 1976 by the International Commission on Illumination. The value 100 represents white or total reflection and the value 0 represents black or total absorption.

In order to calculate the difference between a first lightness L*1 of the texture of the high-contrast sidewall element and a second lightness L*2 of an adjacent sidewall surface portion, it is necessary to measure the first lightness L*1 and the second lightness L*2 respectively using a spectrocolorimeter, for example a KONICA-MINOLTA CM 700D spectrocolorimeter. To measure the first lightness L*1 of the texture, the spectrocolorimeter is positioned on the texture and this measurement is taken using the SCI (specular component included) mode, set at an angle of 8° and with a D65 type light setting (setting as defined by the CIE). Similarly, to measure the second lightness L*2 of an adjacent sidewall surface portion, the spectrocolorimeter is positioned on said sidewall surface portion. In order to improve the determination of this second lightness L*2, it is possible to take a plurality of lightness measurements on several adjacent sidewall surface portions and then to derive an associated mean lightness therefrom.

Advantageously, the texture of the high-contrast sidewall element has a first lightness L*1 at least equal to 1 and at most equal to 15, preferably at least equal to 4 and at most equal to 13.

The lower the lightness of the high-contrast sidewall element when the tire is new, the greater the contrast for a given lightness of an adjacent sidewall surface portion, and the more this contrast will remain significant, over time, on the aged tire. This is because, over time, this first lightness L*1 of the texture of the high-contrast sidewall element tends to increase on account, for example, of dust, dirt, ageing of the material. Moreover, in this lightness range, there is a good contrast with any adjacent sidewall surface portion, which has, in conventional tire designs, a lightness of usually between 24 and 28. Note that a texture with a first lightness L*1, typically at least equal to 9, is easier to produce, but the contrast is low.

Likewise advantageously, any portion of sidewall surface adjacent to the high-contrast sidewall element has a second lightness L*2 at least equal to L*1+5, preferably at least equal to L*1+10 and even more preferably at least equal to L*1+12.

The greater the difference in lightness, the greater the contrast. The greater this difference in lightness on the new tire, the more it will remain significant, over time, on the aged tire.

Also advantageously, any portion of sidewall surface adjacent to the high-contrast sidewall element has a second lightness L*2 at least equal to 18, preferably at least equal to 22.

The rubber composition described in the scope of the present invention is illustrated by the following non-limiting examples.

In order to confirm the properties of the rubber composition of the present invention, eleven rubber compositions (C1, C2, C3, C4, C5 and C6: examples according to the invention, T1: reference, and T2, T3, T4 and T5: comparative examples) were used. Each of the formulations of the rubber compositions is presented in Table 1 with the amounts of the various ingredients expressed in phr.

Each rubber composition was produced as follows: the reinforcing filler, the elastomer matrix, the rubber crumb, the plasticizing agent and the various other ingredients such as the anti-ozone wax, with the exception of the vulcanization system, were successively introduced into an internal mixer having an initial tank temperature equal to 60° C., the internal mixer of “Banbury” type being filled to approximately 70% of its volume. The thermomechanical working (non-productive phase) was then carried out in a single step lasting from 3 to 4 minutes, until a maximum “dropping” temperature of 165° C. was reached. The mixture thus obtained was recovered and cooled, and then the vulcanizing agent (sulfur) and the vulcanization accelerator (N-cyclohexyl-2-benzothiazolesulfenamide) of the crosslinking system were incorporated in an external mixer (homofinisher) at a temperature of 30° C., everything being mixed (productive phase) for a time of more than 5 minutes and less than 12 minutes.

The rubber compositions thus obtained were then calendered in the form of sheets for the measurement of their tear strength and rolling resistance properties according to the following protocols.

With regard to the tear test, the tear strength is measured in the following way. The force to be exerted in order to obtain breaking (FRD, in MPa (in N/mm)) is determined at 100° C. and the strain at break (DRD, in %) is measured at 100° C. Use is made, in order to do this, of a test specimen of dimensions 10×145×2.5 mm, notched at the centre of its length by 3 notches over a depth of 3 mm, in order to cause the test specimen to break. Thus, the energy for bringing about breaking (breaking energy) of the test specimen, which is the product of the FRD and DRD, can be determined. The force to be exerted in order to obtain breaking and the strain at break are measured on a test specimen stretched at 375 mm/min in order to cause the test specimen to break.

The tear performance results are expressed in base 100, the value 100 being attributed to the tear energy of the reference rubber composition (T1). The energy at break values, in base 100, of the rubber compositions tested are presented in Table 2. The higher the value, i.e. the greater the difference in the energy at break compared with the reference, the greater the tear strength, in terms of relative value, i.e. the better the tear performance.

To measure the hysteresis of a rubber composition, an essential parameter with regard to rolling resistance, it is necessary to measure the dynamic properties of the rubber composition. The dynamic properties, such as the shear dynamic elastic modulus (or dynamic modulus) G′, the viscous shear modulus G″, the loss factor tan δ, and the complex dynamic modulus G*, are obtained from measurements carried out on a viscoanalyser (Metravib VA4000) with bonded test specimens of vulcanized rubber compositions. The test specimens used are described in the standard ASTM D 5992-96 (the version published in September 2006 but initially approved in 1996 is used) in Figure X2.1 (circular test specimens). The diameter “d” of each test specimen is 10 mm (the circular cross section is thus 78.5 mm²), the thickness “L” of each test specimen is 2 mm, giving a “d/L” ratio of 5 (as opposed to the standard ISO 2856, mentioned in paragraph X2.4 of the ASTM standard, which recommends a d/L value of 2).

The response of a test specimen of vulcanized rubber composition subjected to a simple alternating sinusoidal shear stress at a frequency of 10 Hz and at a temperature of 23° C. was recorded. A strain amplitude sweep is carried out from 0.1% to 50% (peak to peak on the outward cycle, i.e. 12 measurement points), then from 50% to 0.1% (peak to peak on the return cycle, i.e. 11 measurement points). After each acquisition of data, the shear dynamic elastic modulus (G′) and the viscous shear modulus (G″) on the return cycle, and the loss factor (tan δ), which corresponds to the G″/G′ ratio, were calculated. Similarly, the complex modulus (G*) is defined as the absolute value of the complex sum of the elastic modulus (G′) and of the viscous modulus (G″): G*=(G′2+G″2)^{0.5}.

Each value of tan δ at 10 Hz and at 23° C. is representative of the hysteresis of the corresponding rubber composition, and therefore of the contribution of the rubber composition to the rolling resistance of a tire.

The hysteresis performance results are expressed in base 100, the value 100 being attributed to the reference rubber composition (T1). The results of the hysteresis performance of the examples (C1, C2, C3, C4, C5 and C6) according to the invention and of the comparative examples (T2, T3, T4 and T5) are presented in Table 2. The values indicated correspond to the ratio between the loss factor of the reference composition T1 and that of the rubber composition X: tan δ (T1, 10 Hz, 23° C.)/tan δ (X, 10 Hz, 23° C.)×100, where X represents one of the rubber compositions C1, C2, C3, C4, C5, C6, T2, T3, T4 and T5. The higher the value, the lower the loss factor of the rubber composition, relative to that of the reference, and the better the hysteresis performance, and therefore the lower the contribution of the rubber composition to the rolling resistance, and therefore the rolling resistance.

The formulations of the various rubber compositions are presented in Table 1 below, all the quantities being expressed in phr:

TABLE 1

| Composition | T1 | C1 | C2 | T2 | C3 | T3 | C4 | T4 | C5 | T5 | C6 |
|---|---|---|---|---|---|---|---|---|---|---|---|
| Elastomer (1) | 53 | 53 | 53 | 53 | 53 | 53 | 53 | 53 | 53 | 53 | 53 |
| Elastomer (2) | 47 | 47 | 47 | 47 | 47 | 47 | 47 | 47 | 47 | 47 | 47 |
| Reinforcing | 57 | 36 | 36 | 13 | 29 | 29 | 29 | 10 | 45 | 17 | 29 |
| filler (3) - A | | | | | | | | | | | |
| Rubber crumb | (—) | 21 | 10 | 33 | 17 | 5 | 30 | 17 | 17 | 10 | 17 |
| (4) - B | | | | | | | | | | | |
| Anti-ozone | 1.4 | 1.4 | 1.4 | 1.4 | 1.4 | 1.4 | 1.4 | 1.4 | 1.4 | 1.4 | 1.0 |
| wax (5) | | | | | | | | | | | |
| Plasticizing | 12 | 12 | 12 | 12 | 12 | 12 | 12 | 12 | 12 | 12 | 12 |
| agent (6) - C | | | | | | | | | | | |
| Anti-oxidant (7) | 5.8 | 5.8 | 5.8 | 5.8 | 5.8 | 5.8 | 5.8 | 5.8 | 5.8 | 5.8 | 5.8 |
| Stearic acid (8) | 1.0 | 1.0 | 1.0 | 1.0 | 1.0 | 1.0 | 1.0 | 1.0 | 1.0 | 1.0 | 1.0 |
| Zinc oxide (9) | 1.2 | 1.2 | 1.2 | 1.2 | 1.2 | 1.2 | 1.2 | 1.2 | 1.2 | 1.2 | 1.2 |
| Vulcanization | 1.3 | 1.3 | 1.3 | 1.3 | 1.3 | 1.3 | 1.3 | 1.3 | 1.3 | 1.3 | 1.3 |
| accelerator (10) | | | | | | | | | | | |
| Sulfur | 1.6 | 1.6 | 1.6 | 1.6 | 1.6 | 1.6 | 1.6 | 1.6 | 1.6 | 1.6 | 1.6 |
| Weight ratio | 4.75 | 3.00 | 3.00 | 1.08 | 2.42 | 2.42 | 2.42 | 0.83 | 3.75 | 1.42 | 2.42 |
| A/C | | | | | | | | | | | |
| Sum A + B | 57 | 57 | 46 | 46 | 46 | 34 | 59 | 27 | 62 | 27 | 46 |
| Weight ratio | 0 | 0.58 | 0.28 | 2.54 | 0.59 | 0.17 | 1.03 | 1.70 | 0.38 | 0.59 | 0.59 |
| B/A | | | | | | | | | | | |

(1) Isoprene elastomer: natural rubber;
(2) Butadiene elastomer: cis-1,4 polybutadiene synthesized with a neodymium catalyst having a cis-1,4 bond content of at least 98 mol %;
(3) Carbon black grade ASTM N550 according to the standard ASTM D1765-14 having an STSA measured according to the standard ASTM D6556-10 equal to 39 m²/g, a COAN index measured according to the standard ASTM D3493-16 equal to 85 ml/100 g;
(4) Rubber crumb obtained by recycling (worn tire micronization), and sold by Lehigh Technology, in which the percentage of crumb microparticles retained by a 250 μm screen is less than 1% by weight, measured according to the standard ASTM D5644-01 (2013), and the percentage of crumb particles retained by a 177 μm screen is less than 10% by weight relative to the total weight of the rubber crumb particles, the rubber crumb being unmodified;
(5) Anti-ozone wax sold by Sasol under the commercial reference “Varazon 4959”;
(6) TDAE oil sold by H&R under the commercial reference “VivaTec 500”;
(7) Mixture of 2 anti-oxidants: ((N-(1,3-dimethylbutyl)-N-phenyl-para-phenylenediamine sold by Flexsys under the reference “Santoflex 6-PPD” and 2,2,4-trimethyl-1,2-dihydroquinolone sold by Lanxess;
(8) Stearic acid sold by Uniqema under the reference “Pristerene 4931”;
(9) Zinc oxide: commercial quality, sold by Umicore;
(10) N-dicyclohexy1-2-benzothiazolesulfenamide sold by Flexsys under the reference “Santocure CBS”.
Weight ratio A/C: ratio between the content of reinforcing filler, expressed in phr, and the content of plasticizing agent, expressed in phr;
Sum A + B: sum of the content of reinforcing filler, expressed in phr, and of the content of rubber crumb, expressed in phr;
Weight ratio B/A: ratio between the content of rubber crumb, expressed in phr, and the content of reinforcing filler expressed in phr.

The results of the tear performance and hysteresis performance, respectively, are presented in Table 2 below:

TABLE 2

| Composition | T1 | C1 | C2 | T2 | C3 | T3 | C4 | T4 | C5 | T5 | C6 |
|---|---|---|---|---|---|---|---|---|---|---|---|
| Tear performance | 100 | 186 | 125 | 61 | 109 | 64 | 170 | 46 | 196 | 56 | 110 |
| Hysteresis | 100 | 122 | 129 | 122 | 139 | 154 | 122 | 160 | 110 | 164 | 127 |
| performance | | | | | | | | | | | |

The results in Table 2 show that the rubber compositions according to the invention (C1 to C6) have both the best tear performance and hysteresis performance compared with the reference rubber composition T1 and compared with the comparative rubber compositions (T2 to T5).

In conclusion, the rubber composition according to the invention makes it possible to obtain a sidewall exhibiting a good compromise between tear and hysteresis performance properties, making it possible to have a high-contrast marking that is durable over time, throughout the life of the tire.

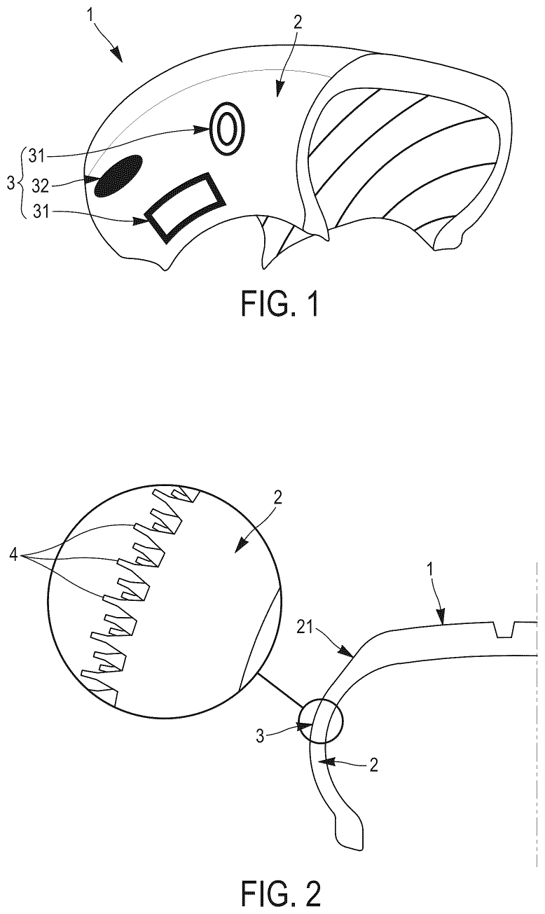

The features of the constituent texture of a high-contrast sidewall element according to the invention are illustrated in the schematic FIGS. 1 to 5, which are not depicted to scale:

FIG. 1: Perspective view of a tire portion comprising a sidewall with high-contrast elements,

FIG. 2: Meridian half-section of a tire comprising a sidewall with a high-contrast element,

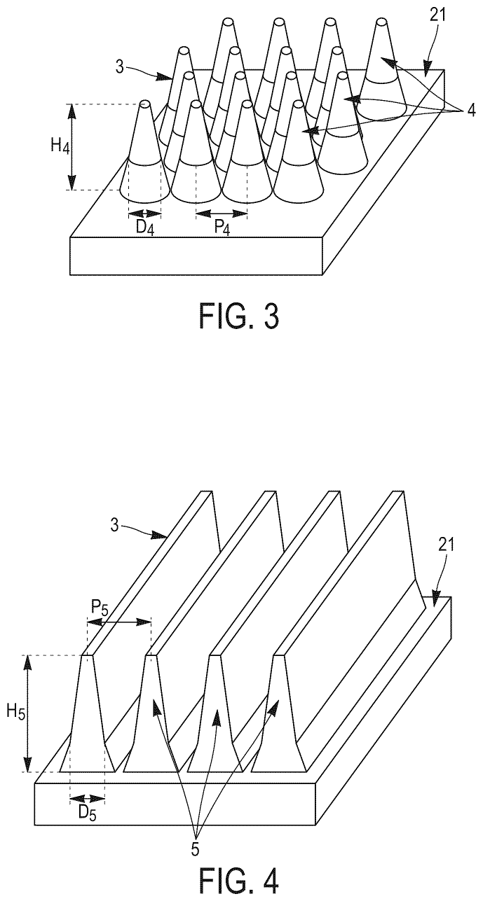

FIG. 3: Texture of a high-contrast element comprising protuberances in the form of strands, according to a first variant of the first preferred embodiment of the texture,

FIG. 4: Texture of a high-contrast element comprising protuberances in the form of strips, according to a second variant of the first preferred embodiment of the texture,

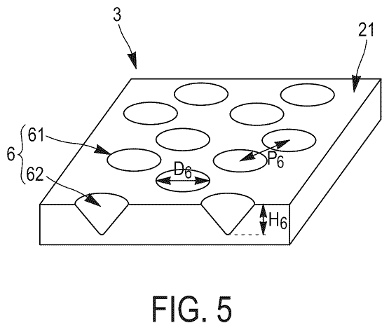

FIG. 5: Texture of a high-contrast element comprising cavities, according to the second preferred embodiment of the texture.

FIG. 1 is perspective view of a tire portion 1 comprising a sidewall 2 with high-contrast elements 3. Depicted among the high-contrast elements 3 are two graphical elements 31, intended to impart technical, commercial or legal information, and an aesthetic element 32.

FIG. 2 is a meridian half-section of a tire 1 comprising a sidewall 2 with a high-contrast element 3 constituted by a texture comprising protuberances 3, which stand out in relief with respect to the surface 21 of the sidewall. The protuberances 4 are in the form of strands, as shown in FIG. 3.

FIG. 3 is a texture of a high-contrast element 3 comprising protuberances in the form of strands 4, according to a first variant of the first preferred embodiment of the texture. The protuberances in the form of strands 4, which stand out in relief with respect to a sidewall surface, have a mean height H₄ at least equal to 0.2 mm and at most equal to 0.8 mm, preferably at least equal to 0.25 mm and at most equal to 0.5 mm. The mean height is understood to be the arithmetic mean of the heights of all of the protuberances. The protuberances in the form of strands 4, which are spaced apart at a mean spacing P₄, are distributed at a surface density at least equal to 5 strands/mm² and at most equal to 100 strands/mm², preferably at least equal to 8 strands/mm² and at most equal to 50 strands/mm², and even preferably at least equal to 11 strands/mm² and at most equal to 30 strands/mm². The protuberances in the form of strands 4, which have a diameter that varies over the entire height of the strand, have a mean diameter D₄ at least equal to 0.03 mm and at most equal to 0.5 mm. In the embodiment shown, the protuberances in the form of strands 4 have a diameter that decreases from a strand base, interfacing with the sidewall surface, and a free strand tip.

FIG. 4 is a texture of a high-contrast element 3 comprising protuberances in the form of strips 5, according to a second variant of the first preferred embodiment of the texture. The protuberances in the form of strips 5, which stand out in relief with respect to a sidewall surface, have a mean height H₅ at least equal to 0.2 mm and at most equal to 0.8 mm, preferably at least equal to 0.25 mm and at most equal to 0.5 mm. The mean height is understood to be the arithmetic mean of the heights of all of the protuberances. The protuberances in the form of strips 5 are distributed at a spacing P₅ at least equal to 0.1 mm and at most equal to 0.4 mm, preferably at least equal to 0.15 mm and at most equal to 0.3 mm. The protuberances in the form of strips 5, which have a width that varies over the entire height of the strip, have a mean width D₅ at least equal to 0.03 mm and at most equal to 0.5 mm. In the embodiment shown, the protuberances in the form of strips 5 have a width that decreases from a strip base, interfacing with the sidewall surface, and a free strip tip.

FIG. 5 is a texture of a high-contrast element 3 comprising cavities 6, according to the second preferred embodiment of the texture. The cavities 6, which are recessed with respect to a sidewall surface, have a mean depth H₆ at least equal to 0.2 mm and at most equal to 0.8 mm, preferably at least equal to 0.25 mm and at most equal to 0.5 mm. The mean depth is understood to be the arithmetic mean of the depths of all of the cavities. A cavity 6 is constituted by a cavity interior 62, formed in the thickness of the sidewall, and an opening 61, which opens onto the surface of the sidewall. The openings 61 onto the sidewall surface, which are spaced apart at a spacing P₆, are distributed at a surface density at least equal to 5 openings/mm² and at most equal to 100 openings/mm², preferably at least equal to 8 openings/mm² and at most equal to 50 openings/mm², and even preferably at least equal to 11 openings/mm² and at most equal to 30 openings/mm². The openings 61 onto the sidewall surface have a mean diameter D₆ at least equal to 0.03 mm and at most equal to 0.5 mm. The mean diameter is understood to be an arithmetic mean of the diameters, which are not necessarily identical, of the openings onto the sidewall surface.

1. The tire for a vehicle, comprising a sidewall with at least one high-contrast sidewall element:
the high-contrast sidewall element being constituted by a texture comprising protuberances, which stand out in relief with respect to a sidewall surface, in contact with the atmospheric air, and/or cavities, which are recessed with respect to the sidewall surface,
the sidewall comprising a rubber composition based on an elastomer matrix, on at least one reinforcing filler, on at least one crosslinking system, on at least one plasticizing agent and on at least one rubber crumb,
wherein the weight ratio between the content of reinforcing filler, expressed in phr, and the content of plasticizing agent, expressed in phr, is at most equal to 4.50, wherein the sum of the content of reinforcing filler, expressed in phr, and of the content of rubber crumb, expressed in phr, is at least equal to 30 phr and at most equal to 70 phr, and wherein the weight ratio between the content of rubber crumb, expressed in phr, and the content of reinforcing filler, expressed in phr, is at least equal to 0.20 and at most equal to 2.50.

2. The tire according to claim 1, wherein the weight ratio between the content of reinforcing filler, expressed in phr, and the content of plasticizing agent, expressed in phr, is at least equal to 1.50, preferably at least equal to 2.00, and at most equal to 4.00, and more preferably at least equal to 2.00 and at most equal to 3.50.

3. The tire according to claim 1, wherein the sum of the content of reinforcing filler, expressed in phr, and of the content of rubber crumb, expressed in phr, is at least equal to 35 phr and at most equal to 65 phr, preferably at least equal to 35 phr and at most equal to 63 phr, and more preferably at least equal to 40 phr and at most equal to 63 phr.

4. The tire according to claim 1, wherein the weight ratio between the content of rubber crumb, expressed in phr, and the content of reinforcing filler, expressed in phr, is at least equal to 0.25 and at most equal to 1.50.

5. The tire according to claim 1, wherein the content of reinforcing filler is at least equal to 5 phr and at most equal to 70 phr, preferably at least equal to 5 phr and at most equal to 60 phr, more preferably at least equal to 5 phr and at most equal to 55 phr, even more preferably at least equal to 10 phr and at most equal to 50 phr, and even more preferably at least equal to 20 phr and at most equal to 45 phr.

6. The tire according to claim 1, wherein the reinforcing filler predominantly comprises carbon black.

7. The tire according to claim 1, wherein the content of plasticizing agent is at least equal to 2 phr and at most equal to 28 phr, preferably at least equal to 7 phr and at most equal to 24 phr, and more preferably at least equal to 10 phr and at most equal to 20 phr.

8. The tire according to claim 1, wherein the at least one plasticizing agent is selected from the group consisting of plasticizing oils, plasticizing resins having a high Tg, and combinations thereof.

9. The tire according to claim 1, wherein the content of rubber crumb is at least equal to 2 phr and at most equal to 35 phr, preferably at least equal to 5 phr and at most equal to 33 phr, more preferably at least equal to 6 phr and at most equal to 32 phr, even more preferably at least equal to 7 phr and at most equal to 31 phr, and even more preferably at least equal to 8 phr and at most equal to 30 phr.

10. The tire according to claim 1, wherein the rubber crumb has a microparticle size distribution such that it comprises less than 1% by mass of microparticles not retained through a 250 μm screen and less than 10% by mass of microparticles not retained through a 177 μm screen, relative to the total mass of the microparticles of rubber crumb.

11. The tire according to claim 1, wherein the high-contrast sidewall element is constituted by a texture comprising protuberances, which stand out in relief with respect to a sidewall surface, having a mean height (H₄, H₅) at least equal to 0.2 mm and at most equal to 0.8 mm.

12. The tire according to claim 11, wherein the high-contrast sidewall element is constituted by a texture comprising protuberances in the form of strands, which are distributed at a surface density at least equal to 5 strands/mm² and at most equal to 100 strands/mm², preferably at least equal to 8 strands/mm² and at most equal to 50 strands/mm², and even preferably at least equal to 11 strands/mm² and at most equal to 30 strands/mm².

13. The tire according to claim 11, wherein the high-contrast sidewall element is constituted by a texture comprising protuberances in the form of strands having a mean diameter (D₄) at least equal to 0.03 mm and at most equal to 0.5 mm.

14. The tire according to claim 11, wherein the high-contrast sidewall element is constituted by a texture comprising protuberances in the form of strands having a diameter that decreases from a strand base, interfacing with the sidewall surface, and a free strand tip.

15. The tire according to claim 11, wherein the high-contrast sidewall element is constituted by a texture comprising protuberances in the form of strips distributed at a spacing (P₅) at least equal to 0.1 mm and at most equal to 0.4 mm.

16. The tire according to claim 15, wherein the high-contrast sidewall element is constituted by a texture comprising protuberances in the form of strips (&& having a mean width (D₅) at least equal to 0.03 mm and at most equal to 0.5 mm.

17. The tire according to claim 15, wherein the high-contrast sidewall element is constituted by a texture comprising protuberances in the form of strips having a width that decreases from a strip base, interfacing with the sidewall surface, and a free strip tip.

18. The tire according to claim 1, wherein the high-contrast sidewall element is constituted by a texture comprising cavities, which are recessed with respect to a sidewall surface, having a mean depth (H₆) at least equal to 0.2 mm and at most equal to 0.7 mm.

19. The tire according to claim 18, wherein the high-contrast sidewall element is constituted by a texture comprising cavities, the openings of which onto the sidewall surface are distributed at a surface density at least equal to 5 openings/mm² and at most equal to 100 openings/mm², preferably at least equal to 8 openings/mm² and at most equal to 50 openings/mm², and even preferably at least equal to 11 openings/mm² and at most equal to 30 openings/mm².

20. The tire according to claim 18, wherein the high-contrast sidewall element is constituted by a texture comprising cavities, the openings of which onto the sidewall surface have a mean diameter (D₆) at least equal to 0.03 mm and at most equal to 0.5 mm.

21. The tire according to claim 1, wherein the texture of the high-contrast sidewall element has a first lightness L*1 at least equal to 1 and at most equal to 15.

22. The tire according to claim 1, wherein any portion of sidewall surface adjacent to the high-contrast sidewall element has a second lightness L*2 at least equal to L*1+5, preferably at least equal to L*1+10 and even more preferably at least equal to L*1+12.

23. The tire according to claim 1, wherein any portion of sidewall surface adjacent to the high-contrast sidewall element has a second lightness L*2 at least equal to 18.
